(19) United States
(12) Patent Application Publication
(10) Pub. No.: US 2016/0366299 A1
(43) Pub. Date: Dec. 15, 2016

(54) SYSTEM AND METHOD FOR ANALYZING AND ROUTING DOCUMENTS

(71) Applicant: Tomoko Sato, San Francisco, CA (US)

(72) Inventor: Tomoko Sato, San Francisco, CA (US)

(73) Assignee: RICOH COMPANY, LTD., TOKYO (JP)

(21) Appl. No.: 14/738,504

(22) Filed: Jun. 12, 2015

(51) Int. Cl. H04N 1/32; G06K 9/00; H04N 1/00

(52) U.S. Cl. CPC H04N 1/32427; H04N 1/00209; H04N 1/0036; H04N 1/32411; G06K 9/00483; H04N 2201/0068; G06K 2209/01

(57) ABSTRACT

An approach is provided for routing received documents. Text documents are received by a document analytics server. The document analytics server accesses a keyword mapping which contains associations between keywords and document destinations. The document analytics server searches the received document for keywords that exist in the keyword mapping and, based on keywords found in the document and the keyword mapping, determines one or more destinations for the document. The document analytics server then routes the document to the one or more destinations.

### FIELD OF THE DISCLOSURE

The present disclosure relates to routing documents based on OCR data and a mapping between keywords and destinations.

### BACKGROUND

Document routing is currently an inefficient process. Documents received through facsimile tend to be either printed out at the facsimile device or generally stored in a data repository. Such a system is cumbersome for companies that receive a large number of facsimiles each day, often directed towards different portions of the company. In the case of a scan operation, a user may not always know the correct destination for each document. Additionally, in the case of a large number of documents, it may be inefficient for a user to manually select each destination for each document.

Generally, document routing systems are useful for digitally sending documents to the correct destinations. For example, some document routing systems use bar codes or QR codes to route documents. The codes are stored in a data repository and mapped to specific users. When a form with such a code is scanned, the code is detected and the document is sent to the correct location. The problem with a code-based system is that it requires the use of pre-printed forms. Often, companies that receive large numbers of facsimiles or that require large numbers of document scans are not in control of the form they receive.

Based on the foregoing, there is a need for a system for routing documents to destinations in a manner that does not require the pre-printing of document codes. Specifically, there is a need for a system that can determine the correct destination for a document based on information in the document that was controlled by an outside source.

### SUMMARY

Techniques are provided for routing documents based on information retrieved from the documents. In an embodiment, a device receives a document image through either facsimile or scanning operations. An Optical Character Recognition (OCR) process is used to create text from the document. A document analytics service receives the OCR data relating to the electronic documents. Based on the OCR data, the document analytics service determines one or more destinations for the document. In an embodiment, the document analytics service sends data that indicates the one or more destinations to a user to determine to which of the one or more destinations to send the document.

The document analytics service may use matching techniques to determine the one or more destinations. In an embodiment, the document analytics service accesses a keyword mapping which maps specific keywords to specific destinations. The document analytics service may search the OCR data for any of the keywords of the keyword mapping. The one or more destinations determined by the document analytics service may correspond to keywords found in the OCR data.

### BRIEF DESCRIPTION OF THE DRAWINGS

In the figures of the accompanying drawings like reference numerals refer to similar elements.

FIG. 1 depicts an example system architecture for routing documents to various devices using a keyword mapping.

FIG. 2 depicts an example system architecture for routing documents to various destinations within a single device using a keyword mapping.

FIG. 3 is a block diagram that depicts an example method for routing documents according to an embodiment.

FIG. 4 depicts an example graphical user interface for updating the document routing system.

FIG. 5 is a block diagram that depicts an example computer system 500 upon which embodiments may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various embodiments are described hereinafter in the following sections:

I. GENERAL OVERVIEW

II. STRUCTURAL OVERVIEW

III. IMAGE CAPTURE AND OCR

IV. KEYWORD MAPPING

V. DESTINATION SELECTION

VI. ADDITIONAL IMPLEMENTATIONS

VII. IMPLEMENTATION MECHANISMS

### I. General Overview

An approach is provided for routing documents based on OCR data. In an embodiment, an image capture device receives a document, such as through an image capture or facsimile. An optical character recognition (OCR) process is used to transform the image of the document into a text data. The document is then searched for one or more predefined keywords that correspond to destinations in a keyword mapping. The document is sent to one or more definitions based on the keywords found in the document and the keyword mapping.

### II. Structural Overview

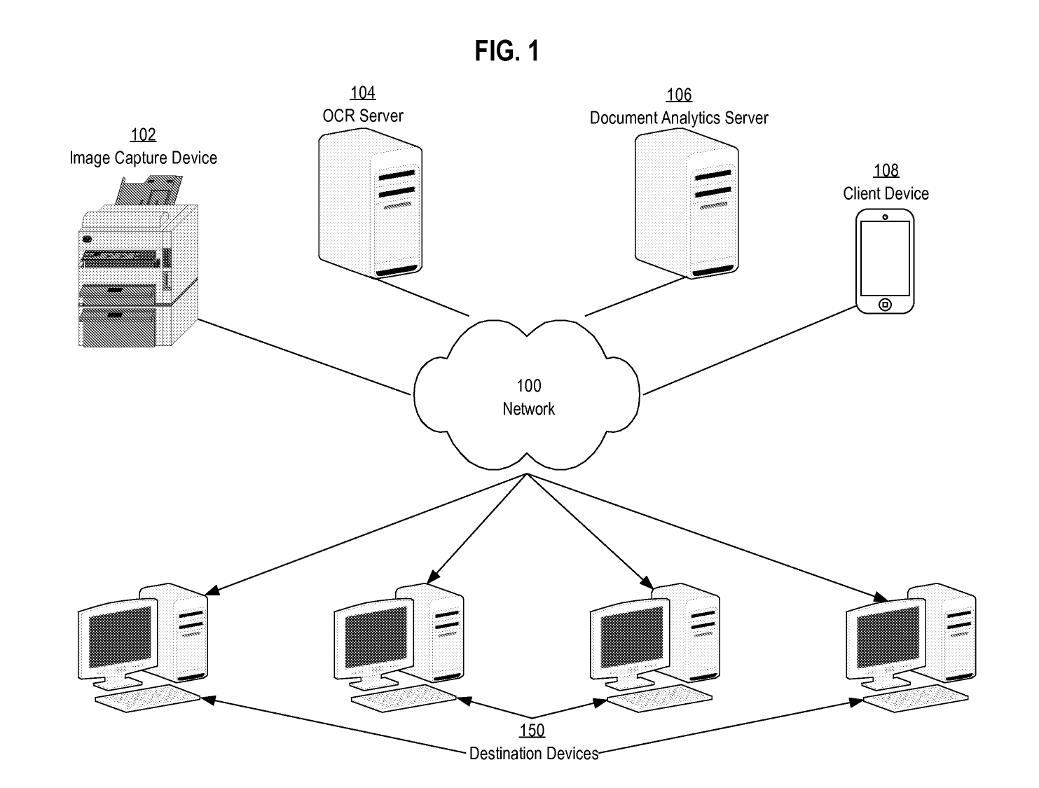

FIG. 1 depicts an example system architecture for routing documents to various devices using a keyword mapping. FIG. 1 contains image capture device 102, OCR server 104, document analytics server 106, client device 108, and destination devices 150 communicatively coupled over network 100. Network 100 may be implemented by any medium or mechanism that provides for the exchange of data between the various elements of FIG. 1. Examples of network 100 include, without limitation, one or more networks, such as one or more Local Area Networks (LANs), one or more Wide Area Networks (WANs), one or more Ethernets or the Internet, or one or more terrestrial, satellite or wireless links. The various elements of FIG. 1 may also have direct (wired or wireless) communications links, depending upon a particular implementation.

In an embodiment, image capture device 102, OCR server 104, document analytics server 106, client device 108, and destination devices 150 may be combined into fewer devices. For example, image capture device 102 may be configured to provide the OCR functions of OCR server 104, the document analytics functions of document analytics server 106, the verification functions of client device 108, or any combination thereof. As an alternate example, image capture device 102 may be limited to image capture and receipt, but a single server may perform the functions of OCR server 104 and document analytics server 106.

Image capture device 102 may be a device configured or programmed to perform one or more functions, such as printing, copying, facsimile, and document scanning. As one example, image capture device 102 may be a scanner. As another example, image capture device 102 may be a multi-function peripheral configured to perform the functions described herein. In some embodiments, image capture device 102 also contains one or more of digitally programmed logic configured to provide OCR functions, digitally programmed logic configured to provide document analytics functions, a keyword mapping database configured to store keywords mapped to destinations, a rules database configured to store rules for document processing, a user interface configured to display destinations and receive input of a specific destination, and a communications component configured to send and receive documents and other data to OCR server 104, document analytics server 106, client device 108, and destination devices 150.

OCR server 104 may be configured or programmed to receive documents and perform OCR functions on the documents to create OCR text data. For example a matrix matching algorithm may be used to compare pixels in the image data with pixels of letters in various fonts stored in a data structure on OCR server 104. Alternatively or additionally, a feature extraction algorithm may be used to compare features in the image data with features of characters in various fonts stored in the data structure on OCR server 104. OCR server 104 may be configured to return the OCR text data to image capture device 102 or to send the OCR data to document analytics server 106.

Document analytics server 106 may be configured or programmed to receive OCR data over a network and perform document analytics functions on the OCR data. Document analytics server may also include a keyword mapping database configured to store keywords mapped to destinations and a rules database configured to store rules for document processing. In an embodiment, document analytics server 106 is configured or programmed to store keyword mappings for each client, indexed by client identification data. Document analytics server 106 may be further configured to send data to and receive data from image capture device 102, client device 108, and destination devices 150. In some embodiments, document analytics server 106 contains a machine learning tool comprising digitally programmed logic, configured to perform pattern matching and document analytics based on prior matches and mismatches.

Client device 108 may be any computing device capable of interacting over a network with document analytics server 106 or image capture device 102. While client device 108 is depicted as a smart phone, client device 108 may also be a personal computer, tablet computing device, PDA, laptop, or any other computing device capable of transmitting and receiving information and performing the functions described herein.

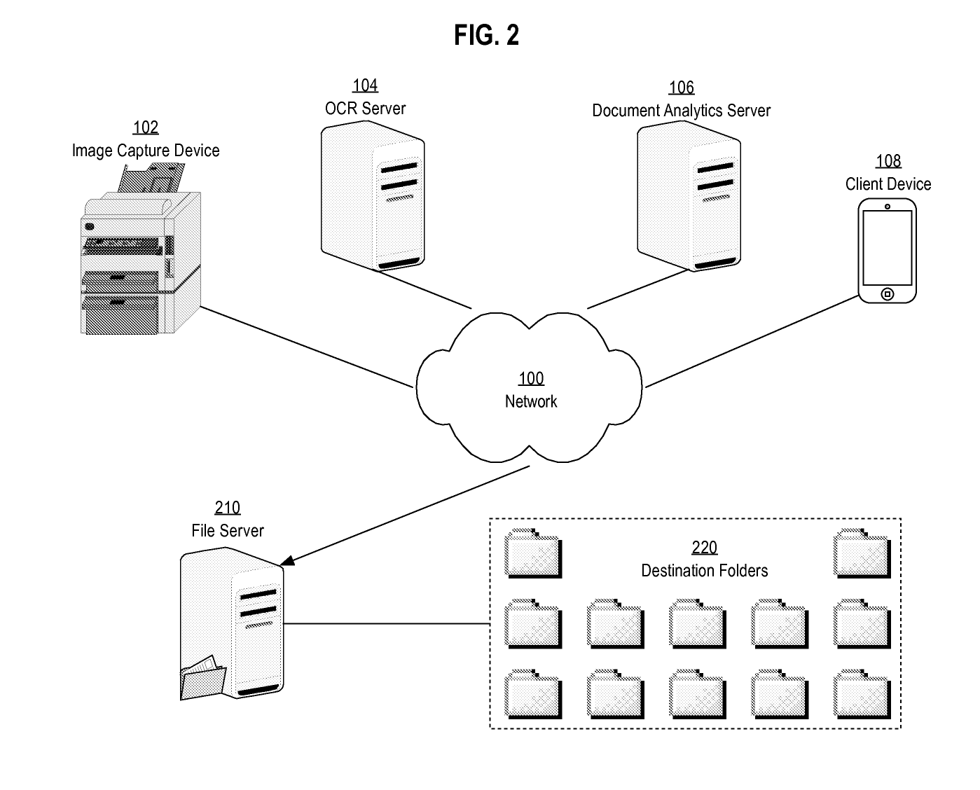

FIG. 2 depicts an example system architecture for routing documents to various destinations within a single device using a keyword mapping. FIG. 2 contains image capture device 102, OCR server 104, document analytics server 106, client device 108, and file server 210 with destination folders 220 communicatively coupled over network 100. File server 210 may be a central data repository configured to store a plurality of documents. Data within file server 210 may be subdivided into destination folders 220. Destination folders 220 represent various storage destinations within file server 210. In various embodiments, combinations of FIG. 1 and FIG. 2 may comprise a system architecture for the routing system and methods described herein. For example, documents may be routed between multiple devices where one or more of the devices contain a plurality of destinations within the one or more devices.

### III. Image Capture and OCR

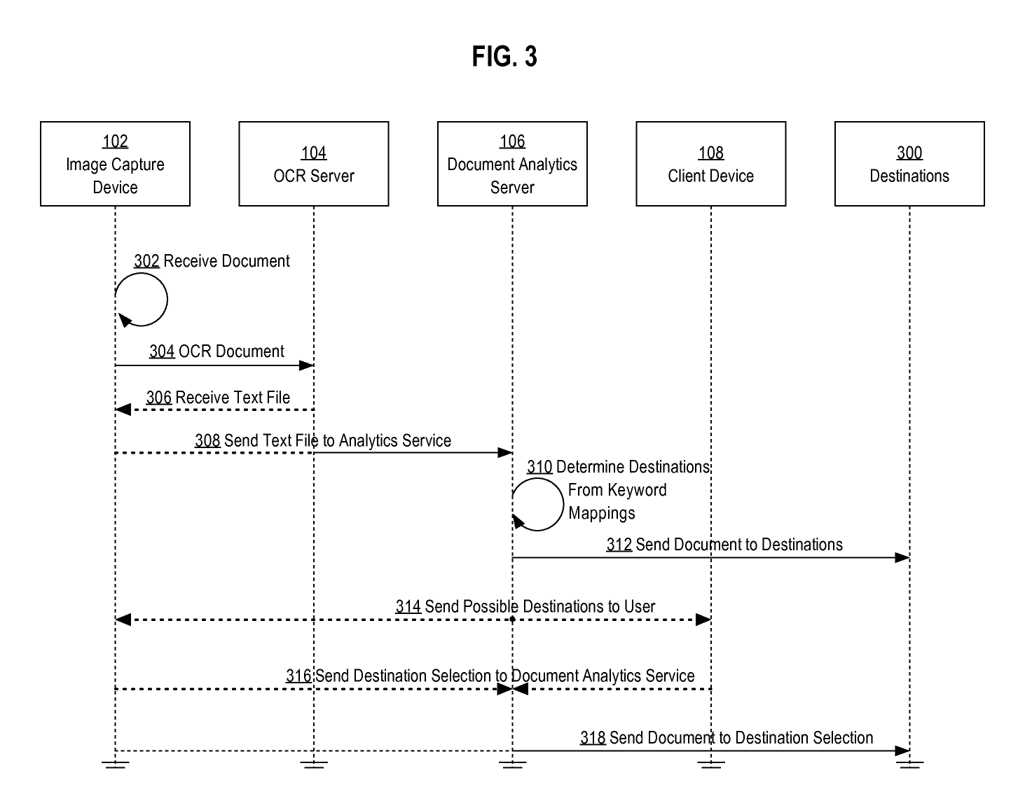

FIG. 3 is a block diagram that depicts an example method for routing documents according to an embodiment. FIG. 3 contains image capture device 102, OCR server 104, document analytics server 106, client device 108, and destinations 300. Destinations 300 may comprise destination devices 150 of FIG. 1, destination folders 220 of FIG. 2, or any combination thereof. The various systems of FIG. 3 may interact over a network as shown in FIG. 1 and FIG. 2.

At step 302, image capture device 102 receives a document. For example, image capture device may be a scanning device that receives a document through a digital scan. Image capture device 102 may also be a facsimile machine that receives image data over a network. Embodiments may also be implemented where image capture device 102 includes a device capable of capturing an image through photography, such as a camera on a mobile phone, tablet, or computing device, and where image capture device 102 receives documents through email.

At step 304, an OCR process is performed on the document. In an embodiment, image capture device 102 contains an OCR module capable of performing the OCR process. In alternate embodiments, the document is sent to OCR server 104 which contains an OCR module capable of performing the OCR process. The OCR module may be implemented using one or more computer programs or other software elements that are loaded into and executed using one or more general-purpose computers, logic implemented in field programmable gate arrays (FPGAs) of application-specific integrated circuits (ASICs).

At step 306, image capture device may receive the text data from OCR server 104. In an embodiment, OCR server 104 is configured to only receive documents from image capture device 102 and return the text document to image capture device 102. In alternative embodiments, OCR server 104 may also communicate with document analytics server 106. For example, OCR server 104 may be configured to receive client identification data from image capture device 102 along with the one or more documents and forward the client identification data with the one or more documents and text data to document analytics server 106, thereby obviating the need to send the text data back to image capture device 102.

At step 308, a text data is sent to an analytics service. For example, either image capture device 102 or OCR server 104 may send the text document to document analytics server 106. In an embodiment, additional data is sent to document analytics server 106, such as an identification of image capture device 102, identification of a user of image capture device 102, contact information for the user of image capture device 102, client identification information, and the original document.

While the method is discussed in terms of documents received as images, the routing methods described herein may be applied to text based documents as well. For example, image capture device 102 may be a general purpose computing device that receives documents over a network, such as through email. If the document is received as an image, an OCR process may be performed on the document to transform it into a text document. If the document is received as a text document, it may be sent to document analytics server 106 as a text document.

### IV. Keyword Mapping

In an embodiment, document analytics server 106 contains or has access to one or more keyword mappings. Document analytics server 106 may contain a different keyword mapping for each logical group or user based on the specific needs of the logical group or user. For example, a first keyword mapping for a first logical group may include a mapping for a particular keyword and a second keyword mapping for a second logical group may have a different mapping for the same particular keyword. As another example, an insurance company may wish to have a keyword mapping related to insurance documents while a law firm may wish to have a keyword mapping related to legal documents. Keyword mappings may be indexed by client identifiers. In an embodiment, document analytics server 106 may be configured to select one or more keyword mapping using received client identification information.

In an embodiment, a keyword mapping is data that identifies one or more keywords and associates each of the one or more keywords with one or more destinations. For example, the keyword “invoice” may be mapped to Computer A while the keyword “Galifianakis” may be mapped to Computer B. In reference to FIG. 3, keywords may be mapped to one or more destinations within a single computing device. For example, in a digital book repository, text with the word “Lovecraft” may be mapped to a “Horror” folder of Computer A, while text with the word “Wells” may be mapped to a “Science Fiction” folder of Computer A. In some embodiments, a keyword may be mapped to multiple destinations. For example, in the digital book repository, text associated with the word “Card” may be mapped to a “Science Fiction” folder and to a “Games” folder.

In an embodiment, multiple keyword mappings are used to create a tiered system for routing documents. For example, a first keyword mapping may map specific keywords to multiple sets of destinations. Additional keyword mappings may be used for each set of destinations to narrow down the list further. For example, an insurance company may have the word “invoice” mapped to one group and the word “claim” mapped to a second group. A second keyword mapping may be used for the “invoice” group and a third keyword mapping may be available for the “claim group.” The “invoice” mapping may include associations between client identifiers and computers in the billing department while the “claim” mapping may include associations between the same client identifiers and computers in the claims department.

In some embodiments, a first keyword mapping identifies a first computing device and a second keyword mapping identifies destinations within a computing device. For example, the keyword “invoice” may be used to identify an accounting computing device in the first keyword mapping and a second keyword mapping may map invoice numbers to related folders within the accounting computing device.

According to an embodiment, the keyword mappings also contain negative mappings. A negative mapping may involve certain keywords that are associated with destinations in a manner that indicates that documents with the specific keyword should not be sent to the associated destination. For example, a specific attorney may be screened from a case or client due to a conflict of interest. The keyword mapping may contain a negative mapping of the case or client name to the specific attorney, such that if the case or client name is found in the document, the document is not sent to the specific attorney. In an embodiment, the negative mappings completely override any other mappings. Thus, if a document containing words relating to a specialty of the specific attorney also contain the name of a conflicting client, the mapping of the attorney to the specialty would be overridden by the negative mapping of the attorney to the client.

### V. Destination Selection

Referring again to FIG. 3, at step 310 a destination is determined from the keyword mappings. For example, document analytics server 106 may search the text data for keywords identified by the keyword mapping. When a keyword is found, document analytics server 106 may select the corresponding destination or destinations from the keyword mapping. If multiple different keywords are found, multiple destinations may be selected. Alternatively, a particular destination may be selected based upon machine learning, weightings or rankings, as described in more detail hereinafter.

In an embodiment, at step 312 the document is sent to one or more selected destinations. Sending the document to one or more selected destinations may comprise digitally transmitting the document through a web service, such as email, or remotely accessing a computing device over a network to store the document in a specific location on the computing device. Additional rules may be applied to choose a destination from the selected destinations, as discussed in herein. In some embodiments, the document is sent to multiple destinations 300, such as each destination identified by the keyword mapping or a subset of the identified destinations.

In an alternate embodiment, at step 314 the possible destinations are sent to the user. In some embodiments, possible destinations are only sent to the user if more than one destination has been selected. In other embodiments, possible destinations are sent to the user regardless of the number of destinations selected. Sending the possible destinations to the user may comprise transmitting a list of destinations to image capture device 102 or to client device 108.

Step 314 may comprise document analytics server 106 sending the possible destinations to image capture device 102. In an embodiment, image capture device 102 is configured to display a list of destinations. For example, image capture device 102 may contain a programmable display that can be used to display the list of destinations to a user. The user may select from the list of destinations one or more chosen destinations for the document. For example, in the “Card” example, the list may contain “Science Fiction” and “Games”. The user, aware that the received document related to the book “Ender's Game,” would select “Science Fiction.” In some embodiments, the list of destination may include a “more options” selection for the situations where the desired option is not available. For example, if the document relates to credit card transactions that occurred over the past month, both the “Science Fiction” and “Games” options would be incorrect. A selection of “more options” may cause image capture device to display the rest of the possible destinations.

Step 314 may also comprise document analytics server 106 sending the possible destinations to client device 108. Client device 108 may execute a software application that receives updates from document analytics server 106. In an embodiment, sending the possible destinations to client device 108 includes document analytics server 106 sending a message to the user through an application programming interface (API) of the application executing on the user device. The application may display the selected destinations to the user. As with the display on image capture device 102, “more options” may be included in the list of options to allow a user to choose a different destination for the document from the ones that are displayed.

In other embodiments, document analytics server 106 uses contact information of the user to send a message to client device 108. For example, document analytics server 106 may receive an email address for the user from image capture device 102. Alternatively and/or additionally, document analytics server 106 may have the email address of the user stored in a data repository, indexed by user identification information. Document analytics server 106 may receive the user identification information and access the data repository to retrieve the email address of the user. The email may contain a uniform resource locator (URL) to a website hosted by the document analytics server. The URL may cause client device 108 to access the website through a browser executing on client device 108. Document analytics server 106 may display the selected destinations to the user through the website. Document analytics server 106 may also display “more options” to allow the user to select an option that is not displayed.

In some embodiments, document analytics server 106 returns an error if no keywords are found. For example, document analytics server 106 may send a message to image capture device 102 that causes image capture device 102 to display an error on the interface. Image capture device 102 may then request input from the user specifying the destination of the document. In some embodiments, a keyword creation option is displayed to the user if no keyword is found in the document or if the user does not select one of the displayed options. The keyword creation option may allow the user to select a portion of the text data that may be used to route to the chosen destination. For example, if a document contains the name of a new client of Person A, the user may select the name of the client from the text data to create a new keyword mapping that maps the client name to a device or folder associated with Person A. In other embodiments, a default destination may be used if document analytics server 106 is unable to find a keyword in the text data.

Referring back to FIG. 3, at step 316, the user selection is sent to document analytics server 106. At step 318, document analytics server 106 sends the documents to destinations 300. In some embodiments, after the user selects the destination from a display of image capture device 102, image capture device 102 sends the document directly to destinations 300. Image capture device 102 may still send the selection to document analytics server 106 for use in validating or correcting the current routing method.

In an embodiment, a notification is sent to client device 108 when the document is sent to destinations 300. The notification may include identification of destinations 300, identification of the document, and identification of the keyword that was used to choose the destination. The notification may be sent by email or through an API of an application executing on client device 108. Alternatively, a notification may be sent to image capture device 102. Image capture device 102 may display the notification on a display of image capture device 102.

An index may also be created that stores the locations of received documents. The index may be stored on document analytics server 106, image capture device 102, destination devices 150, file server 210, client device 108, or a separate computing device. For each document, the index may indicate one or more of an identification of the sender of the document, an identification of the scanner of the document, an identification of a user of client device 108 and/or an identification of client device 108, the date and time of the receipt of the document, the location of the document, or the keyword used to select the location of the document from the possible destinations. In an embodiment, document analytics server 106 sends data that causes an index stored on separate device to be updated. For example, document analytics server 106 may send the document to destination devices 150 and may additionally send data to a separate computer that causes the index stored in the separate computer to be updated with an entry for the new document.

### VI. Machine Learning

In an embodiment, document analytics server 106 is configured or programmed with a machine learning tool that uses prior matches and mismatches to increase the accuracy of destination selections. The machine learning tool may comprise digitally programmed logic that performs pattern matching and document analysis. For example, if a user continually selects the “invoice” destination for each document that contains the keywords “invoice” and “claim,” document analytics server 106 may stop showing the “claim” option when both keywords are found in a document. If a user later selects the “claim” option for a document that contains both keywords, document analytics server 106 may begin showing the “claim” option again. The machine learning tool may also perform more complex analyses, such as matching document types, finding additional language in the documents that narrow the options, or comparing all documents sent to a single destination for similarities.

Matching document types may include comparing multiple documents to find a pattern in the locations of specific strings. For example, patient information forms that are filled out by a patient will always contain matching words in matching locations, such as “Personal Information,” “Name,” “Address,” “Do You Have Any of the Following Allergies,” etc. The machine learning tool may match determine that forms with matching patterns are frequently selected to go to the same destination. For example, the machine learning tool may determine that documents with the pattern of a patient information form are always sent to an administrative computing device. In some embodiments, the pattern recognition is used in a more complex manner, such as to determine one of multiple places to send a document or determine a destination within a computing device to send a document. For example, if the patient information forms are frequently sent to both the administrative computing device and a separate computing device dependent which is dependent on the patient's name, document analytics server 106 may select the administrative computing device based on the pattern matching and the doctor's device based on the patient's name. As another example, the patient's name may be used to select a folder for the patient while the pattern matching may be used to select a subfolder, such as “patient information.”

Finding additional language in the documents that narrow the options may include finding words that make it more likely that a document goes to a specific destination or less likely that a document goes to a specific destination. For example, document analytics server 106 may determine that documents containing the phrase “social security number” are rarely sent to a scheduling computing device. Document analytics server 106 may choose to not display an option for the scheduling computing device if “social security number” is found in the document, regardless of other keywords found in the document. Additionally, document analytics server 106 may determine that documents with the phrase “Resident Dorian” are frequently sent to the computing device of “John Dorian” and/or his supervisor “Dr. Perry Cox.” If a keyword is found in a document that is mapped to a large number of doctors, document analytics server 106 may use the phrase “Resident Dorian” to narrow the selection to the aforementioned computing devices.

In an embodiment, document analytics server 106 may begin automatically sending documents to destinations 300 based on previous matches. For example, if documents with a particular keyword are consistently sent to Computer A, document analytics server 106 may begin automatically sending documents with that keyword to Computer A without requesting a user selection. Additionally, if the machine learning tool detects a specific pattern in documents that, in conjunction with a particular keyword, correlates highly to the document being sent to Computer A, document analytics server 106 may automatically send documents that match the specific pattern and contain the particular keyword to Computer A.

In an embodiment, the keyword mappings also contain rankings for the keywords. The rankings may be used to narrow down a group of selected destinations, to order the group of selected destinations, or to choose a specific destination from the group of selected destinations to which to send the document. For example, the keyword “invoice” may be mapped with a higher ranking than the keyword “claim.” If both keywords are found in the document, the word “invoice” would take priority. In some embodiments, the priority of “invoice” would mean that the document is automatically sent to the computing device mapped to the word “invoice.” In other embodiments, the priority of “invoice” would mean that the computing device mapped to “invoice” would be placed higher on the list of selected destinations than the computing device associated with the word “claim.”

In some embodiments, the frequency of a keyword may be used to narrow down a group of selected destinations, to order the group of selected destinations, or to choose a specific destination from the group of selected destinations to which to send the document. For example, a document sent to a media reviewing company may contain the words “page” and “scene.” “Page” may be mapped to a “Books” destination and “Scene” may be mapped to a “TV/Movies” destination. If the word “page” is used a large number of times while the word “scene” is used once, document analytics server 106 may send the document directly to the “Books” destination or place the “Books” destination at the top of the list of selected destinations.

Weightings may also be used to narrow down a group of selected destinations, to order the group of selected destinations, or to choose a specific destination from the group of selected destinations to which to send the document. Weightings may refer to the relative importance of a specific keyword. If only one instance of each keyword is found, the weightings may be indistinguishable from rankings. If multiple instances of each keyword are found, the weightings may be used to determine a ranking of destinations. For example, in the media reviewing company example, the word “scene” may have a relatively low weighting due to the fact that many forms of media refer to scenes. “Page,” on the other hand, may have a relatively high weighting due to the fact that pages are rarely discussed in connection with forms of media other than books. Thus, a document may use the word “scene” more frequently than the word “page,” but the weightings for the words may cause document analytics server 106 to rank the “Books” destination higher than the “TV/Movies” destination. Weightings may be used with, or without, machine learning.

### VI. Administrative Control

In an embodiment, document analytics server 106 provides a graphical user interface for an administrative computing device. The administrative computing device may be client device 108, one of destination devices 150, file server 210, or a separate computing device. The graphical user interface may provide the administrative computing device with tools for establishing permission control, keyword creation, analytics correction, keyword rankings, rule creation, and rule deletion. The administrative computing device may log into the document analytics system using one or more unique identifiers, such as a user name and password.

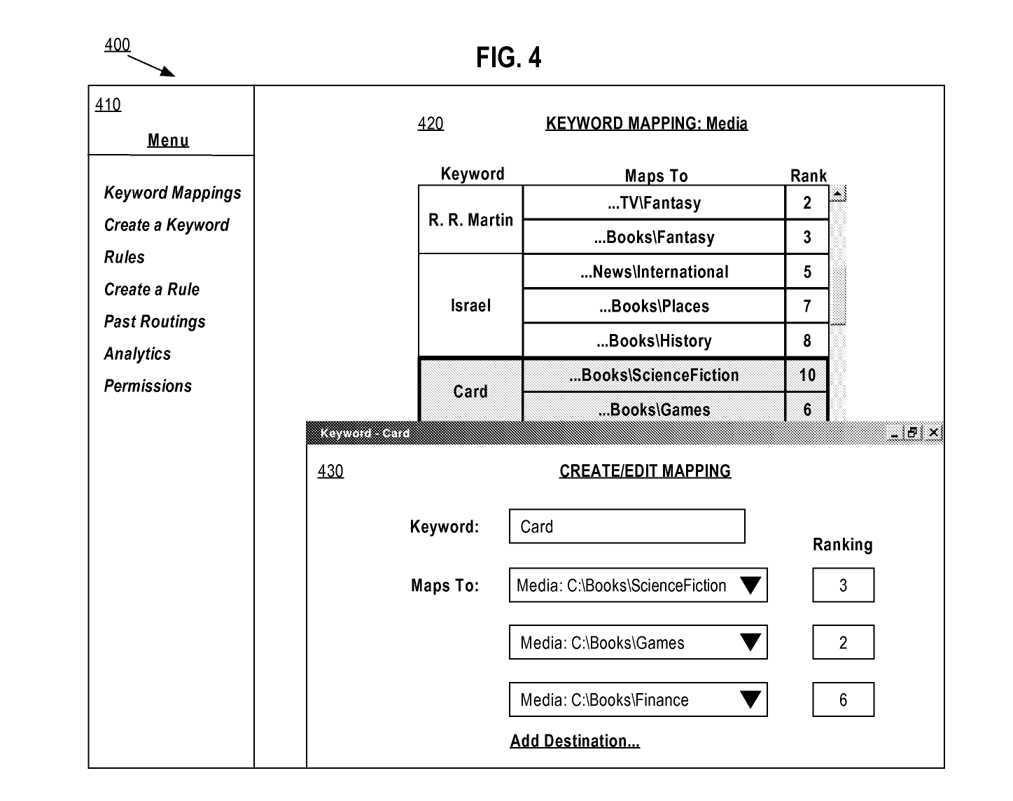

FIG. 4 depicts an example graphical user interface for updating the document routing system. Interface 400 contains menu 410, keyword mapping 420, and mapping editor 430. The particular organization and presentation of a graphical user interface for updating the document routing system is not limited to the example depicted in FIG. 4 and the particular organization and presentation may vary depending upon a particular implementation. Menu 410 contains various options for updating the document routing system or viewing information about the document routing system. In the embodiment depicted in FIG. 4, menu 410 includes Keyword Mappings, Create a Keyword, Rules, Create a Rule, Past Routing, and Permissions.

Interface 400 may be configured to display keyword mapping 420 when it receives a selection of Keyword Mappings from menu 410. In an embodiment, interface 400 may first display multiple keyword mappings. Upon receiving a selection of a specific keyword mapping, interface 400 may display keyword mapping 420. For example, a tiered system may contain an overall keyword mapping that is used to determine a second tier keyword mapping. In the embodiment depicted in FIG. 4, the overall keyword mapping may contain keywords that map to “Media,” “Accounting,” “Legal,” and “Administrative” keyword maps. Interface 400 may be configured to display the five keyword mappings initially until interface 400 receives a selection of one of the keyword mappings.

Keyword mapping 420 may display the keywords, the mapped destinations, and a ranking or weighting for the individual mapping. For example, keyword mapping 420 depicts the keyword “R. R. Martin” mapped to . . . TV\Fantasy and . . . Books\Fantasy. In some embodiments, each keyword is mapped to a single destination, allowing the system to have greater control in automatically sending documents to a single destination. In other embodiments, such as the embodiment depicted in FIG. 4, a keyword may be mapped to multiple destinations. Each mapping may contain a ranking of weighting. For example, the mapping of “R. R. Martin” to . . . TV\Fantasy contains a ranking of 2 while the mapping of “R. R. Martin” to . . . Books\Fantasy contains a ranking of 3. Based on the rankings, document analytics server 106 may prioritize one destination over the other in sending destinations to the user or in sending the documents to the destinations. For example, document analytics server 106 may automatically send the document to the destination with the highest associated ranking. As another example, document analytics server 106 may order the destinations by ranking, such that the highest ranked destination is displayed first to a user.

In some embodiments, keyword mapping 420 contains weights in addition to or instead of rankings A weight may differ from a ranking in that the weights may be combined with instances of a keyword to affect the prioritization of documents. For example, four instances of a keyword with a weight of 2 may outweigh two instances of a keyword with a weight of 3. Additionally, weights may be combined across keywords to create more complex rules. For example, the word “Card” in keyword mapping 420 is mapped to . . . Books\ScienceFiction and . . . Books\Games. Though “Card” is not mapped to any of the same destinations as “R. R. Martin,” “Card” is mapped to similar destinations, such as . . . Books. In determining the final destination or destinations of the documents, the similarity between destinations may give weight to a particular destination. Thus, instances of both “R. R. Martin” and “Card” in a single document may increase the likelihood that document analytics server 106 prioritizes . . . Books\Fantasy as a destination over . . . TV\Fantasy. As with rankings, document analytics server 106 may automatically send the document to the highest weighted destination or order the destinations by weighting. Document analytics server 106 may also apply a threshold value to select one or more destinations. For example document analytics server 106 may be configured to only select destinations that receive a weighting above 10. Thus, four instances of a keyword with a weight of 3 may be selected while two instances of a keyword with a weight of 4 may not be selected. Document analytics server 106 may send the document to the selected destination or order the selected destinations by weighting.

Interface 400 may be configured to display mapping editor 430 after receiving a selection of a keyword or destination from keyword mapping 420 or a selection of Create a Keyword from menu 410. Mapping editor 430 may display options for creating keywords, adding destinations to new or existing keywords, removing destinations from new or existing keywords, adding weights or rankings to destinations, and removing weights or rankings from destinations. Additionally, mapping editor 430 may display options for changing keywords, destinations, mappings, weights and/or rankings.

Interface 400 may be configured to display current or past rules upon receiving a selection of Rules from menu 410. The rules may consist of user created rules and/or rules created by document analytics server 106. In some embodiments, the rules comprise overarching procedures. For example, a rule may specify that the system returns an error if it is unable to find a keyword, unable to validate the permission settings of a user, or determines that a specific folder has not been set for the keywords. Additionally, rules may specify how the system reacts to discovering one or more keywords. For example, a rule may specify that the system automatically sends the documents to the top prioritized destination. More complex rules may specify that the system automatically sends the documents to a destination if only one keyword is found or if there is a specified difference between the ranking and/or weights of the keywords found. Other complex rules may involve pattern matching rules such as those created by the machine learning tool of document analytics server 106.

Upon receiving a selection of a rule from the displayed rules or receiving a selection of Create a Rule from menu 410, document analytics server 106 may display an interface for creating or editing a rule. Additionally, the rule creation and editing interface may allow the creation of priorities for the rules or the deletion of one or more unwanted rules.

Interface 400 may be configured to display past document routings upon receiving a selection of Past Routings from menu 410. The past document routings may include the date of the routing, the destinations to which the document was routed, the other selected destinations, an identification of the user who initiated the routing or selected the destination, the keywords and rules applied to the routing, and any other information about the document or routing. In some embodiments, interface 400 may be configured to receive corrections through the past routings interface. For example, interface may receive a selection of a past routing and a corrected destination. Document analytics server 106 may be configured to use the corrected destination with the machine learning tool to create or change current rules. Additionally or alternatively, document analytics server 106 may be configured to display extra destinations based on the corrected destination. In some embodiments, document analytics server 106 may stop sending documents to destinations automatically if it receives a specified number of corrections.

Interface 400 may be configured to display routing analytics upon receiving a selection of Analytics from menu 410. Routing analytics may include data describing the number of documents routed, the number of corrections made, the number of documents containing each keyword, and the accuracy of routing predictions. Routing analytics may also include recognized patterns, such groups of keywords that appear in documents sent to specific destinations along with an accuracy rating for the pattern to the destinations. In some embodiments, the routing analytics may be used to create new rules. For example, interface 400 may be configured to display a “Create Rule” button next to each set of analytics. In an embodiment, the “Create Rule” button opens a rule creation interface related to the analytics. For example, if an analytics entry shows that documents with the words “invoice” and “claims” have a 95% chance of being sent to Computer A, a selection of the analytics entry may cause the display of a rule creation interface that depicts a combination of “invoice” and “claims” being mapped to Computer A. In this way, document analytics server 106 may use the machine learning tool to determine correlations, but wait for administrative approval before creating a rule.

Interface 400 may be configured to display permission controls upon receiving a selection of Permissions from menu 410. Permission controls may include controls for setting access rules, such as users that may request a document routing, users that may select destinations, users that may correct the selected destinations, and users with administrative control.

### VII. Implementation Mechanisms

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

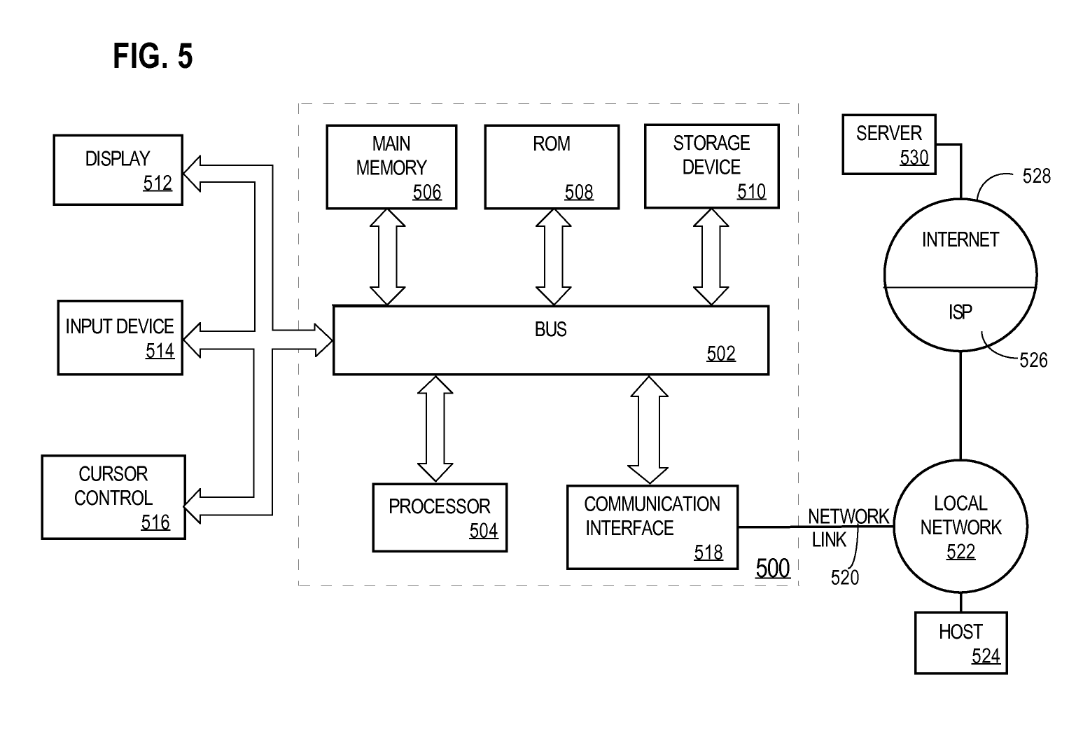

FIG. 5 is a block diagram that depicts an example computer system 500 upon which embodiments may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. Although bus 502 is illustrated as a single bus, bus 502 may comprise one or more buses. For example, bus 502 may include without limitation a control bus by which processor 504 controls other devices within computer system 500, an address bus by which processor 504 specifies memory locations of instructions for execution, or any other type of bus for transferring data or signals between components of computer system 500.

An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic or computer software which, in combination with the computer system, causes or programs computer system 500 to be a special-purpose machine. According to one embodiment, those techniques are performed by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments are not limited to any specific combination of hardware circuitry and software.

The term “computer-readable medium” as used herein refers to any medium that participates in providing data that causes a computer to operate in a specific manner. In an embodiment implemented using computer system 500, various computer-readable media are involved, for example, in providing instructions to processor 504 for execution. Such a medium may take many forms, including but not limited to, non-volatile media and volatile media. Non-volatile media includes, for example, optical or magnetic disks, such as storage device 510. Volatile media includes dynamic memory, such as main memory 506. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution.

In the foregoing specification, embodiments have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method for routing a received document to one or more end destinations comprising:
receiving, at a document analytics service, OCR data relating to one or more electronic documents;
identifying one or more keywords in the OCR data;
accessing one or more keyword mappings that map keywords to end destinations;
determining one or more end destinations for the one or more electronic documents based, at least in part, on the one or more keywords in the OCR data and the one or more keyword mappings;
in response to determining one or more end destinations for the one or more electronic documents, sending to an image forming device or client computing device data that identifies the one or more end destinations;
receiving a selection of a particular end destination; and
causing the one or more electronic documents to be sent to the particular end destination in response to receiving the selection of the particular end destination.

2. The method of claim 1, wherein:
a first mapping of a first keyword of the one or more keywords to a first end destination of the one or more end destinations is associated with a first ranking;
a second mapping of a second keyword of the one or more keywords to a second end destination of the one or more end destinations is associated with a second ranking;
determining one or more end destinations for the one or more electronic documents comprises:
determining that the first ranking has greater importance than the second ranking; and
selecting the first destination to be included in the one or more end destinations instead of the second end destination based upon the first ranking having greater importance than the second ranking.

3. The method of claim 1, wherein the one or more end destinations comprise one or more end destination folders within a file server.

4. The method of claim 1, wherein sending data that indicates the one or more end destinations comprises:
sending, to the client computing device, an email containing a URL that corresponds to an email account associated with a user of the client device; and
causing a web page to be displayed on the client computing device in response to a user selection of the URL;
wherein the web page indicates the one or more end destinations.

5. The method of claim 1, wherein sending data that indicates the one or more end destinations comprises:
sending the data that indicates the one or more end destinations to the image forming device;
wherein the one or more electronic documents were initially captured by the image forming device; and
causing the image forming device to display the one or more end destinations.

6. The method of claim 1, further comprising:
storing log information identifying the one or more electronic documents, the one or more keywords, and the particular end destination;
receiving second OCR data relating to second one or more electronic documents;
identifying the one or more keywords in the second OCR data;
accessing the one or more keyword mappings and the log information; and
causing the second one or more electronic documents to be sent to the particular end destination based at least in part on the one or more keyword mappings and the log information.

7. The method of claim 1, further comprising:
receiving data that indicates a request from the user for additional end destinations;
causing data that indicates additional end destinations to be sent to the image forming device or client computing device;
wherein the particular end destination is one of the additional end destinations.

8. The method of claim 1, further comprising:
causing to be displayed to a user on a client device, a graphical user interface comprising one or more of:
one or more graphical user interface controls for creating keywords of the one or more keywords;
one or more graphical user interface controls for creating end destinations of the one or more end destinations;
one or more graphical user interface controls for creating mappings of keywords of the one or more keywords to end destinations of the one or more end destinations; or
one or more graphical user interface controls for creating rankings for the mappings.

9. The method of claim 1, wherein:
the OCR data is received from an image forming device;
the image forming device received the one or more electronic documents via facsimile or via scanning; and
the image forming device created the OCR data from the one or more electronic documents.

10. The method of claim 1, further comprising causing to be sent to a user, one or more notifications that identify the one or more electronic documents and the one or more end destinations where the one or more electronic documents were sent;
wherein causing to be sent to a user, the one or more notifications that identify the one or more electronic documents includes:
causing an image forming device to display the one or more notifications that identify the one or more electronic documents; and/or
causing an email to be sent to an email account associated with the user, wherein the email contains the one or more notifications.

11. One or more non-transitory computer readable media storing instructions, which when executed by one or more processors, cause performance of:
receiving, at a document analytics service, OCR data relating to one or more electronic documents;
identifying one or more keywords in the OCR data;
accessing one or more keyword mappings that map keywords to end destinations;
determining one or more end destinations for the one or more electronic documents based, at least in part, on the one or more keywords in the OCR data and the one or more keyword mappings;
in response to determining one or more end destinations for the one or more electronic documents, sending to an image forming device or client computing device data that identifies the one or more end destinations;
receiving a selection of a particular end destination; and
causing the one or more electronic documents to be sent to the particular end destination in response to receiving the selection of the particular end destination.

12. The one or more non-transitory computer readable media of claim 11, wherein:
a first mapping of a first keyword of the one or more keywords to a first end destination of the one or more end destinations is associated with a first ranking;
a second mapping of a second keyword of the one or more keywords to a second end destination of the one or more end destinations is associated with a second ranking;
determining one or more end destinations for the one or more electronic documents comprises:
determining that the first ranking has greater importance than the second ranking; and
selecting the first destination to be included in the one or more end destinations instead of the second end destination based upon the first ranking having greater importance than the second ranking.

13. The one or more non-transitory computer readable media of claim 11, wherein the one or more end destinations comprise one or more destination folders within a file server.

14. The one or more non-transitory computer readable media of claim 11, wherein sending data that indicates the one or more end destinations comprises:
sending, to the client computing device, an email containing a URL that corresponds to an email account associated with a user of the client device; and
causing a web page to be displayed on the client device in response to a user selection of the URL;
wherein the web page indicates the one or more end destinations.

15. The one or more non-transitory computer readable media of claim 11, wherein sending data that indicates the one or more end destinations comprises:
sending the data that indicates the one or more end destinations to the image forming device;
wherein the one or more electronic documents were initially captured by the image forming device; and
causing the image forming device to display the one or more end destinations.

16. The one or more non-transitory computer readable media of claim 11, wherein the instructions, when executed by the one or more processors further cause performance of:
storing log information identifying the one or more electronic documents, the one or more keywords, and the particular end destination;
receiving second OCR data relating to second one or more electronic documents;
identifying the one or more keywords in the second OCR data;
accessing the one or more keyword mappings and the log information; and
causing the second one or more electronic documents to be sent to the one or more end destinations based at least in part on the one or more keyword mappings and the log information.

17. The one or more non-transitory computer readable media of claim 11, wherein the instructions, when executed by the one or more processors further cause performance of:
receiving data that indicates a request from the user for additional end destinations;
causing data that indicates additional end destinations to be sent to the image forming device or client computing device;
wherein the particular end destination is one of the additional end destinations.

18. The one or more non-transitory computer readable media of claim 11, wherein the instructions, when executed by the one or more processors further cause performance of:
causing to be displayed to a user on a client device, a graphical user interface comprising one or more of:
one or more graphical user interface controls for creating keywords of the one or more keywords;
one or more graphical user interface controls for creating end destinations of the one or more end destinations;
one or more graphical user interface controls for creating mappings of keywords of the one or more keywords to end destinations of the one or more end destinations; or
one or more graphical user interface controls for creating rankings for the mappings.

19. The one or more non-transitory computer readable media of claim 11, wherein:
the OCR data is received from an image forming device;
the image forming device received the one or more electronic documents via facsimile or via scanning; and
the image forming device created the OCR data from the one or more electronic documents.

20. The one or more non-transitory computer readable media of claim 11, wherein the instructions, when executed by the one or more processors further cause performance of causing to be sent to a user, one or more notifications that identify the one or more electronic documents and the one or more end destinations where the one or more electronic documents were sent;
wherein causing to be sent to a user, the one or more notifications that identify the one or more electronic documents includes:
causing an image forming device to display the one or more notifications that identify the one or more electronic documents; and/or
causing an email to be sent to an email account associated with the user, wherein the email contains the one or more notifications.
